(19) United States
(12) Patent Application Publication
(10) Pub. No.: US 2012/0203584 A1
(43) Pub. Date: Aug. 9, 2012

(54) SYSTEM AND METHOD FOR IDENTIFYING POTENTIAL CUSTOMERS

(76) Inventors: Amnon Mishor, Tel Aviv (IL); Roy Bar-Haim, Ramat Gan (IL); Eyal Shpin, Kefar Yona (IL)

(21) Appl. No.: 13/367,562

(22) Filed: Feb. 7, 2012

Related U.S. Application Data
(60) Provisional application No. 61/440,221, filed on Feb. 7, 2011.

(51) Int. Cl. G06Q 10/00

(52) U.S. Cl. 705/7.11

(57) ABSTRACT

A system and method for identifying potential customers is provided. Information in a proprietary data repository of a company may be analyzed to thereby determine a first set of textual terms. Publicly available information related to the existing customer set may be analyzed to thereby determine a second set of textual terms. Terms in the first and second sets may be associated with scores. A customer profile may be generated based on the textual terms and associated scores. Potential customers may be identified based on the buyer profile. Other embodiments are described and claimed.

### CROSS-REFERENCE TO RELATED APPLICATIONS

This application claims benefit of U.S. Provisional Patent Application No. 61/440,221, filed Feb. 7, 2011, all of which is incorporated in its entirety herein by reference.

### BACKGROUND OF THE INVENTION

Customer management systems e.g., customer relationship management (CRM) systems are known in the art. Customer management systems are employed for managing a company's interactions with customers. For example, a CRM may be used to organize, automate, and synchronize business processes related to marketing, customer service or technical support. However, although used for managing or retaining existing customers, current customer management systems do not readily enable identifying, locating or finding new customers.

Identifying potential or new customers may be a major goal for a business or a company. Although identifying a potential lead or contact in very small organizations may be a relatively easy task, in other organizations, there may be many possible candidates. For example, employees in an organization may be associated with different departments, may have various seniority levels and/or may be associated with various products etc. Accordingly, a system and/or method for identifying potential customers or good leads are highly desirable. However, current systems and methods do not enable automatically identifying potential customers, e.g., determining the most relevant leads or contacts in a businesses or organization.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows an exemplary system and flow according to embodiments of the invention;

FIG. 2 shows an exemplary system according to embodiments of the invention;

FIG. 3 shows an exemplary association of weights with classes of features according to embodiments of the present invention; and

FIG. 4 shows high level block diagram of an exemplary computing device according to embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

Identifying potential customers, clients or purchasers, also referred to herein as “leads” may be a major goal for a business or a company. The terms, “potential customer”, “potential client”, “potential buyer” and “lead” may be used interchangeably herein and may all refer to any applicable entity that may engage in a purchase or transaction. For example, a lead may be an employee in a position to authorize or encourage a purchase. The terms “candidate customer” or “candidate buyer” may be used herein to refer to a potential customer, client or buyer who is being assessed by a system or method in order to determine whether the candidate entity is a relevant or good lead. Generally, a good lead may be an entity who is likely to buy a product or service.

To further illustrate the notion of “good leads” as referred to herein, consider a company selling virtualization products, which may also be described as “cloud enablement platforms”. A good lead, relevant prospect, potential customer or contact point would typically be an employee in the Research and Development (R&D) or Information Technology (IT) departments in the organization. A relevant potential customer or lead should additionally have sufficient seniority level to be a decision maker. In small organizations this may be the Chief Technology Officer (CTO). In large organizations, there may be many possible candidates who match the required department and seniority level, and choosing the most relevant ones amongst them becomes a challenging task.

The present invention enables a method for discovering, identifying and/or locating leads, prospects or potential customers, based on an existing customer set of the company, e.g., based on leads currently stored in a company's proprietary data repository (or any other applicable repositories). Given a sample of leads, that may be assumed to be representative examples of the target or searched for leads, a method according to embodiments of the invention may generate a buyer model, examine publicly available information related to business professionals or potential customers, for example, information in professional networks and business directories, and identify, retrieve and/or provide leads that best match the buyer profile. In some embodiments, a user may constrain the search to find leads only in a given company or companies. A user may cause a system to only search for leads related to a specific product, service, a specific domain or a specific field. In other embodiments, leads or potential customers may be searched and retrieved based on any applicable criteria. A system according to embodiments of the invention may search for leads based on any applicable criteria provided by a user. For example, in some exemplary embodiments, potential customers may be searched for a specific product or service or only in companies of a predefined size. In other examples, leads may be searched according to geographical regions, in companies associated with a specific industry etc. A buyer model may be generated based on various criteria. For example, a buyer model may be generated for a specific product or service, such buyer model may then be used to find potential buyers who are most likely to be interested in buying the product or service.

Using a buyer model or profile to identify potential customers may be according to various rules, criteria, requirements or constraints. For example, the type, size, location or other aspects related to a company may be indicated by a user such that potential customers identified using a buyer model will only be employees of companies that meet the rules, criteria, requirements or constraints. For example, only contact points in companies located in the west coast, or companies of a specific minimum size may be provided as output by a system based on a buyer model. The same buyer model may be used by a system to provide different results when different requirements are received, e.g., a business field, a product etc. For example, a requirement may be related to the actual person being selected as a potential buyer and not the company employing the person. For example, a job function, a job title and/or a seniority level within an organization may all be received as input and used in searching for potential buyers that meet these constraints or requirements. Other parameters that may be used may be related to a service or a product, a business domain that may be any aspect related to a business of a potential customer or a corporate entity (e.g., a department).

Embodiments of the invention may examine a person's job title and may determine whether the person is either a good or a bad lead. For example, in the above example (a company selling virtualization products), titles such as “Manager of middleware integration” or “Director of enterprise architecture” may be determined as highly indicative of good matches. Title matching may include assessing or ranking the seniority level or relevance and ranking the domain relevance.

Embodiments of the invention may determine, based on a titles of a person that the person has an appropriate seniority level (e.g., “Director” or “Manager”) and the product (e.g., cloud enablement platform) is highly relevant to the person's specific responsibilities in the organization (e.g., “enterprise architecture”, “middleware integration”). In some embodiments, titles may be used to filter out bad leads. For instance, titles such as “QA Manager” or “CFO” may be determined irrelevant in the above example. Accordingly, if such titles are detected, the related person or contact may not be selected as a good lead or potential customer. Any other information related to a potential leads may be used to filter out bad leads. For example, a term or phrase detected in a free text section of a professional profile may cause excluding the related lead from a list of selected leads provided to a user.

In some cases, an embodiment may determine that a title only provides weak positive evidence, and may process additional information related to a possible lead in order to determine whether the lead is a good or bad one, or determine if the lead qualifies as a match, e.g., based on a buyer model or a customer profile. For example, titles like “IT Manager” or “Director of Engineering” in the above virtualization products example may indicate the required seniority level and department, but may be determined to be too general to determine the relevance of the product to their actual responsibilities in the organization.

Embodiments of the invention may use information in person profiles in a professional or social network to obtain additional details about the person's job function. For example, job titles are often followed by job descriptions in free text. In the above virtualization products example, the existence of keywords such as “cloud”, “SaaS” or “virtualization” in a job description of an “IT manager” may be recorded by an embodiment of the invention and may cause the embodiment to increase a score of the contact. In some embodiments, a lead may be identified or selected based on a domain relevance that may generally be described as the relatedness of the job function to a target domain. A target domain may be a product or service to be sold or any applicable transaction to be conducted with to potential customers. A lead may additionally or alternatively be identified, scored or selected based on a seniority level.

According to embodiments of the invention, a customer model or profile may be generated and used to find and/or identify leads. A model or profile may be generated such that the job titles and key terms of good leads are identified or defined and represented in the model. The model or profile may be used to identify potential customers (or good leads) by matching one or more titles of a person with title parameters in a model. A lead may be identified, scored or selected based on matching key terms identified in information related to the lead with key terms in a model or profile.

Candidate leads, e.g., persons or other entities identified in a search, may be ranked and/or scored. A lead scoring model (or scoring model for short) may be used to rank candidate leads. A scoring model may be generated based on a number of resources. A customer or buyer profile may include, or be associated with, a scoring model such that potential customers are selected and ranked according to the scoring model.

In some embodiments, a customer profile and a scoring model may be used. For example, a customer profile may be used to select a subset of potential customers from a set of candidate leads or candidate customers and a scoring model may be used to rank the subset of potential customer. In another embodiment, a buyer profile or customer profile may be any combination of a scoring model and a profiling model. In other embodiments, a buyer profile may include, or be associated with a scoring model and a set of search terms. It will be apparent in the discussion herein that any combination of profiles or models may be used by a system or method as described herein. Accordingly, the terms customer profile, buyer profile, scoring model or lead scoring model may be used herein interchangeably and it will be understood that all the above terms may refer to a collection of rules, parameters and/or criteria that may be used in order to identify a candidate lead and/or analyze information related to a candidate lead in order to determine whether the candidate lead is a good lead and/or rank the candidate lead or customer.

A scoring model or a buyer profile may be generated based on a set of “good” leads also referred to herein as a sample or sample set. A buyer profile and/or scoring model may be generated based on an existing customer set. For example, a sample may be obtained from the user's customer relationship management (CRM) system. Each lead may include the person name, job title and company, and possibly additional information. Information retrieved from a proprietary repository such as a CRM may be enriched, extended or updated by looking up each person in professional networks and retrieving additional information, e.g., the person's professional profile. The system may record the frequencies of recurring terms or patterns in the sample titles, and may use these statistics for scoring new titles. A system may compute term frequencies for terms extracted from the professional profiles, and may use such or other statistics for scoring key terms.

A buyer profile may be dynamically and/or automatically updated, improved or otherwise modified using any, possibly large collections or corpora of titles and professional profiles that may represent the general population of business professionals, possibly related to a specific domain. These corpora may be used to improve a scoring model, by increasing the score of titles or key terms whose relative frequency is higher in a sample of known leads (e.g., an existing customer set) than in the general population, and decreasing the significance of very common terms. For example, term frequency and inverse document frequency” (TF-IDF) as known in the art may be used to associate terms with scores. A scoring model may be generated based on user input. For example, a user may provide information parameters to be used in searching and/or scoring leads. For example, a set of key terms, a company's name or website may be provided by a user to a system, and key terms may be extracted based on such input.

User input may be received at various points during a generation or maintenance of a scoring model and/or a buyer profile. For example, a system may present to a user categories of terms and associated ranking or scores and prompt or enable the user to provide input. For example, a user may be enabled to manually adjust scores associated with categories of terms. In another embodiment, a user may be able to mark or define a term, concept, cluster or category of terms as either negative or positive. A term or cluster of terms defined as negative may cause a rejection of a candidate lead or client (or a lowering of a rank of the candidate client) if terms found in information related to the candidate lead are included in the negative cluster, concept or category.

For example, if it is determined that people from the marketing department are not proper contact points for a specific product then the term “marketing” may be characterized or marked as a negative indicator. Such characterization or marking of a term may cause any candidate lead who belongs to a marketing department to be rejected or given a low score. Similarly, marking a category as a positive indicator may cause an automatic raising of a rank of candidate clients who are associated with the category via terms found in their respective professional profiles. Weights may be associated with terms in a scoring model or buyer profile. For example, weights may be assigned automatically by a system. For example, based on a frequency of appearance of a term in information related to known good leads, the system may assign a score or weight to the term. A set of terms (and/or categories or concepts) may be displayed to a user and the user may be enabled to adjust weights associated with terms or otherwise manipulate weights or scores described herein.

A scoring model may be initially generated during a learning phase, that may take place prior to a system's first use. An outcome of a learning phase may be a set of search terms, aimed to retrieve candidate leads with good coverage (recall) and high precision. The scoring model and the search terms may be collectively referred to herein as a buyer profile. A buyer profile may be provided to a system and used in a search for potential customers, also referred to herein as a prospecting process.

When initiating a search for potential customers (a prospecting process), a user may provide various parameters, rules, indications or criteria. For example, the user may indicate a specific company and the system may produce a potential buyer (or contact point) in the indicated company. In other scenarios, a list of companies may be provided to the system, a specific product or service may be indicated and so on.

Using learned search terms as described herein, the system may query available online resources such as professional networks and business directories, and may retrieve professional profiles of candidate leads. The candidate leads may be ranked, e.g., using a scoring model described herein, and may be presented to a user. The user may provide feedback on the returned leads. Leads, contacts or potential customers or buyers may be provided to a proprietary repository (e.g., a CRM) directly from a system according to embodiments of the invention.

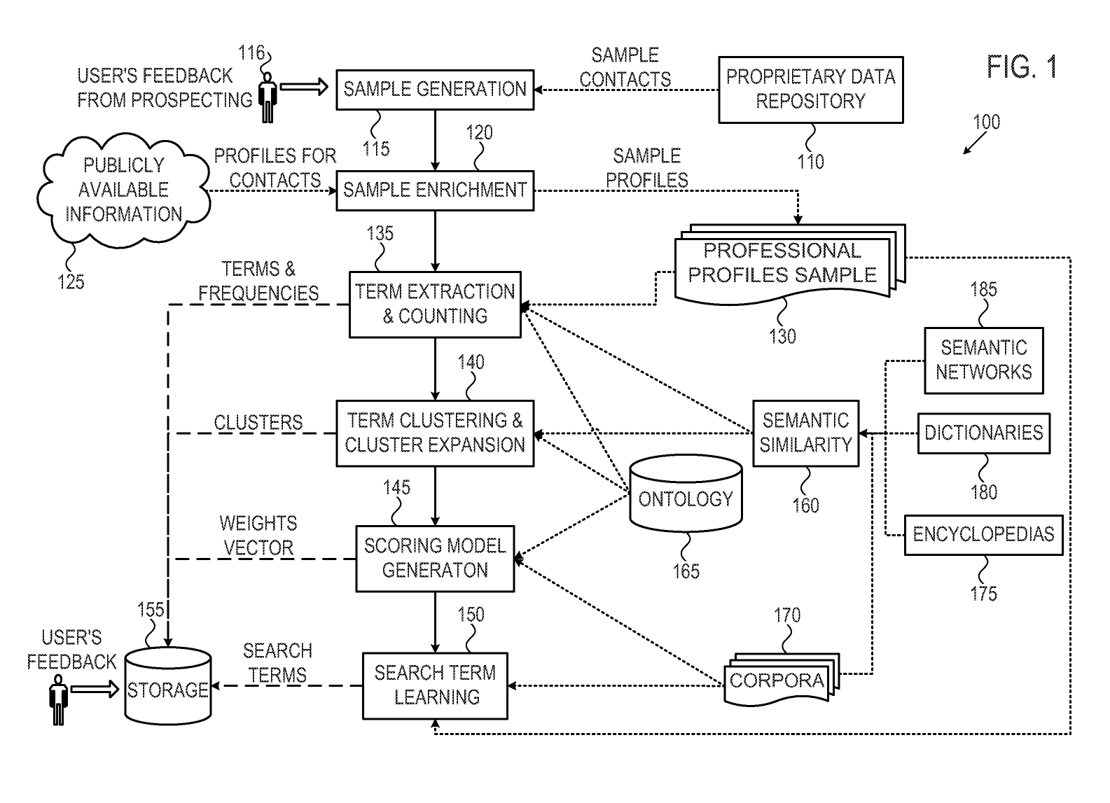

Reference is made to FIG. 1 which shows an exemplary system 100 and a flow according to embodiments of the invention. It will be understood that the system shown in FIG. 1 and described herein is an exemplary system and other systems or configurations are possible according to embodiments of the invention. Accordingly, in some implementations, some of the components shown in FIG. 1 may be omitted, replaced or combined. For example, a single unit, module or device may perform term extraction and clustering and model generation as described herein.

Generally, a method according to embodiments of the invention may include a learning phase or process. As shown by proprietary data repository 110, system 100 may have access to a repository of contacts or information related to existing customers. For example, repository 110 may be a CRM system, an enterprise resource planning (ERP) system or another repository that stores information related to an existing customer set of a company. As shown by sample generation module 115, sample contacts may be retrieved from proprietary data repository 110. The set of sample contacts may be used as input to a learning process that may define or identify aspects of potential customers.

In one embodiment, sample generation module 115 may produce a subset or sample set of contacts stored in the user's CRM (or other databases). The subset may be selected from the entire existing customer set of a company. For example, sample generation module 115 may select contacts according to criteria defined by the user, such as industry, geographic area or specific products that were sold or offered to these contacts. In some embodiments, the size of the sample set may vary from a few dozens to a few thousand contacts. As shown by user's feedback 116, a user may provide input, e.g., to sample generation module 115. For example, a user may rank or annotate existing customers or contacts. For example, buyers may be ranked highest, opportunities may be ranked higher than leads, and so on. User input may be used, e.g., by sample generation module 115 in order to select contacts for further processing. For example, sample generation module 115 may provide (e.g., on a display screen of a computing device) a list of contacts retrieved from repository 110 and a user may indicate suitable contacts or indicate contacts which should not be used for further processing. Accordingly, a buyer profile may be generated or modified based on a selected set of known or existing customers. Additionally or alternatively, a buyer profile may be generated based on a rule or criteria.

As further described herein, user's feedback 116 may include indications from a user with respect to leads produced by a prospecting process. For example, potential leads identified by a system may be presented to a user who may indicate whether a lead is either a good lead or a bad lead. Based on user's feedback 116, data in proprietary data repository 110 may be updated. For example, a set of leads stored in proprietary data repository 110 may be updated by adding to the set a lead identified by a system and indicated by a user as a good lead to the set of leads. Following an addition of leads to proprietary data repository 110 based on input from a user, sample generation module 115 may generate (or regenerate) a new set of sample contacts or leads that may include leads added to proprietary data repository 110 as described herein.

The new set of sample contacts may be used as input to a learning process. Accordingly, a system may use input from a user in order to extend, update, improve or otherwise maintain a sample of representative leads that may be used in order to generate or update a buyer profile, search terms or other data or parameters usable in a prospecting process.

As shown by sample enrichment module 120 and publicly available information 125, system 100 may obtain and analyze publicly available information related to a set of existing customers. Publicly available information related to an existing customer set as shown by 125 may be personal profiles and may be used to enrich the information on each contact or existing customer. For example, sample enrichment module 120 may retrieve information from professional and/or social networks or from business directories. Using a name or other reference of an existing customer or contact, sample enrichment module 120 may search the Internet for information related to the existing contact. In some embodiments, a contact's first and last name and the name of the of the employing company may be retrieved from a proprietary repository (e.g., a private CRM or ERP system) and may be used to obtain information related to the contact from social or professional networks, e.g., facebook® and/or LinkedIn®. It will be understood that any publicly available information (as shown by 125) may be obtained and used and that embodiment of the invention are not limited by information in a specific social or professional network. For example, publicly available information may be retrieved from any internet site, from an online library or encyclopedia and the like. Any parameter may be used in order to find information related to an existing customer. For example, in order to find information related to a customer, the customer's job title, email or location may be used in order to improve matching accuracy.

In some cases, fuzzy name matching of persons and companies may be required, and accordingly performed (e.g., by sample enrichment module 120), in order to overcome differences such that, for example, HP and Hewlett-Packard or IBM and I.B.M are treated as the same entities or terms. As shown by professional profile sample 130, a sample of professional profiles (or other information related to clients) may be provided to term extraction and counting module 135. Term extraction and counting module 135 may extract and/or count terms from any sample, e.g., retrieved from a CRM system, retrieved from the internet or otherwise obtained.

As shown by term extraction and counting module 135, terms may be extracted from information. Terms extracted may be counted or otherwise processed. Information obtained from a proprietary data repository of a company may be analyzed to thereby determine a first set of textual terms. Information obtained from publicly available resources may be analyzed to thereby determine a second set of textual terms. For example, given a list of contacts sampled from a private CRM and the additional information on these contacts such as found in personal profile in a professional network, personal records in a business directory or other public information, system 100 may identify and/or extract terms (e.g., words or phrases) which may be suspected as key terms (or salient terms) in a target domain.

In some cases, the most relevant information for modeling the person's job function is the information related to the current position (the current job title and description), and, to a lesser extent, information that describes the person's expertise and professional interests (e.g., “summary” and “skills” sections, and the list of “groups and associations”, all typically found in professional social networks records).

Professional profiles typically contain several sections, which provide information about a person's specialties, current and past employment, education, awards, publications etc. Some of the sections in professional profiles (e.g. groups and associations) may be structured as a list of terms. Extracting domain-related terms from job titles may be accomplished by identifying predefined terms which may be short and/or have a known structure. Term extraction from a title may include breaking a complex title comprising multiple job titles to its parts based on markers such as “/”, “,” “and” or “&”. For example, the title “Head—Mobile Development/Managing Partner” may be converted, or split into, two titles, e.g., “Head—Mobile Development” and “Managing Partner”. In order to verify that a complex term was correctly split, an embodiment may ascertain each resulting part contains a “core” job function term, such as head, partner, engineer etc. Core job function terms may be provided as a list of predefined terms. Term extraction from a title may further include removing words indicating seniority level such as head, manager, senior etc. For example, “Content Marketing Manager” may be converted to “Content Marketing” and “Head of Mobile” may be converted to “Mobile”. Term extraction from a title may include removing irrelevant terms including descriptive terms such as “hands-on”, geographic locations and so on. Term extraction may include further splitting the resulting terms according to punctuation marks (e.g. “-”, “:”, “&”) and conjunction words (e.g., “and”, “for”). For instance, extracting from the title “Business Development—LBS, Lifestyle & Gadgets” the terms LBS, Lifestyle and Gadgets. If duplicate terms are identified they may be eliminated from the final result of a term extraction process.

Key terms may be identified and/or extracted, e.g., by term extraction and counting module 135, from free text. In order to extract terms from free text, term boundaries may need to be identified. Additionally, the relevance of an identified term to the current job function depends on the context in which the term appears in the text. Accordingly, in order to correctly identify or recognize terms in free text, system 100 may automatically determine relevant contexts.

A method of extracting terms from free text with relatively high confidence may include extracting only terms that were found in “safer” sections (e.g., structured lists and titles). A method may further include expanding a term until a separator such as punctuation mark or function word is reached. The method may include identifying a context based on terms in a title and related terms in related free text. In some embodiments, terms identified in a free text section may be used in order to extend or identify terms in a title or vice versa. Extracting or identifying terms may be an iterative process in which terms identified in a first portion or section (e.g., a title) may be used to identify or extend terms in a second portion or section (e.g., free text). New terms identified or determined in the second section may then be used in order to determine, identify or extract terms from the first section, and so on. For example, starting with the word “Mobile” appearing in the title “Head of Mobile”, terms discovered in related free text, e.g., “Mobile Application Development” or “Mobile Testing” may be used in order to define a context or define a target domain.

A method may include using any applicable algorithm, e.g., using a collocation discovery algorithm, to process free text. A collocation discovery algorithm may discover multi-word expressions by applying a statistical test to detect words or phrases that co-occur together significantly more than chance. The results may be further improved by applying a part-of-speech filter, allowing only certain part-of-speech patterns such as “noun noun” (e.g. “automation tools”) and/or “adjective noun” (e.g., “social networks”). Identified collocations, as well as individual words that are not part of the collocations, may be taken as candidate terms. Candidate terms that have high degree of semantic similarity to terms extracted from “safer” section may be extracted from the text. For example, the algorithm may discover the expression “cloud computing” in the text. The term may be determined to have a high semantic similarity with the term SaaS found in the title, and therefore it may be extracted for further use, e.g., as described herein. For each extracted term, system 100 may record the number of times it occurs at each section in the sample (e.g. the term “SaaS” appeared 15 times in the current job title section, and 8 times in the summary section).

According to embodiments of the invention, clusters may be defined and terms may be associated with clusters. For example, a set of terms related to a high-level concept may be clustered together in a cluster that may be included in an ontology (e.g., as shown by ontology 165). Clusters may be associated with weights or any other parameters that may be used in a scoring or ranking process. Clusters may further be associated with classes or types and may be given a name. For example, “Employee Relations”, “Recruiter”, “Staffing” and “Chief Human Resources Officer” may be part of a cluster representing the concept “Human Resources”, and is of type “Department”.

Generally, a cluster may be a set of terms that represent a higher-level concept. For example, term clustering and clustering expansion module 140 may identify terms related to a concept and associate such terms with a cluster. An ontology maintained by a system may include a representation of one or more real world domains or concepts. Concepts (or the representing clusters) may have types such as department, level, job function, field etc. For example:

Software Testing (textual term)→Quality Assurance (job function) or

Software Testing (textual term)→R&D (department)

Additionally, an ontology may cluster together synonymous textual terms, e.g. {HR IS, HR Information Systems, Human Resources Information Systems, Human Resource Information Systems} or {Executive Vice President, Executive VP, EVP}.

An ontology may contain both general and domain-specific knowledge and may be continuously maintained and expanded over time. An ontology may allow making generalizations while learning from a sample, by mapping textual terms into higher-level concepts. For example, suppose that the titles in a sample contain the terms “branding”, “marketing” “strategy” and “E-commerce”. Knowing that these terms are all part of “Marketing” would increase the likelihood that people in the marketing department are good leads. Accordingly, the terms “branding”, “marketing” “strategy” and “E-commerce” may be associated with a “Marketing” cluster. Furthermore, the ontology may map into the concept “Marketing” other terms that did not appear in the sample, thereby increasing coverage as well.

A term may be mapped in an ontology to any number of concepts (e.g., the term may be associated with a number of clusters). For example:

Team Lead→Manager Level (Level)

Recruitment→Human Resources (Department)

Wireless→Mobile (Field)

Software Testing→Quality Assurance (job function)

Software Testing→R&D (Department)

An ontology may contain both general knowledge, applicable for a wide range of domains (such as “Level” concepts), and more domain-specific knowledge, such as “Field” concepts. An ontology may be continuously updated by content experts (analysts), either manually or semi-automatically, by reviewing and filtering the outcome of automatic processes as described herein. Any information related to clusters (e.g., the set of terms associated with a cluster, the cluster's name and/or type) may be stored, e.g., as shown by ontology 165. Clusters in an ontology may be expanded by a system, for example, using semantic similarities. In some embodiments, semantic similarity measures may be used to expand existing clusters with previously unknown or unseen terms. Semantic similarity measures may be used associate previously unknown or unseen terms with new concepts or clusters.

In an embodiment, a system may automatically compute semantic similarities between a textual term included in a cluster and a new term (e.g., a textual term identified in a profile). Based on a computed similarity, the new term may be automatically added to the cluster. For example, a similarity or relatedness measure, score or value may be determined using a variety of statistical methods applied to a large collection of textual terms (e.g., in information related to professionals as described herein), or by using available large-scale semantic networks and/or encyclopedic resources. Any other methods or systems may be used in order to expand a cluster. For example, using the synonyms in online dictionaries, terms may be added to a cluster automatically.

By dynamically and/or continuously associating terms with new concepts, or mapping terms into ontology clusters, a system may add to a buyer profile terms that did not appear in an inspected or analyzed sample of existing leads. A buyer profile may be generated based on terms included in a cluster even if the terms were not detected in a sample of existing customers. For example, a first term may be identified in a sample of customers and may be included or represented in a buyer profile. A system may inspect an ontology and determine that the first term is associated with a cluster. The system may inspect the cluster, determine that a second term is included in the cluster and therefore, include the second term in the buyer profile (even though the second term was not identified or detected in a sample of customers).

Clusters may be expanded or modified manually by the user. For example, clusters and associated terms may be displayed to a user that may add/remove terms to/from a cluster, change a cluster's name or weight etc. In an embodiment, based on a frequency of appearance of unknown terms in a sample of known customers, a system may display the unknown terms to a user and prompt the user to define a new cluster or associate the terms with an existing cluster.

New clusters may be generated by a system. For example, terms identified in a sample but left unassociated with clusters may be processed. For example, using semantic similarities techniques, terms may be clustered. For example, terms identified in a sample which are not associated with existing clusters in an ontology may be analyzed for similarities and clustered in new clusters. Accordingly, an ontology may be expanded automatically by a system based on newly identified terms.

Clusters may be associated with weights or other parameters. Evaluation of terms may include determining a term is associated with a cluster and further determining that the term is important because it is associated with a prominent cluster. As further described herein, in a scoring or prospecting process, a score associated with a potential customer may be based on terms detected in information related to the potential customer. When calculating a score based on a detected term, a system may first determine whether the term is associated with a cluster and, if so, the weight or other parameter of the associated cluster may be used in computing the contribution of the term to a score of the potential customer. Accordingly, a score may be based on a term and on an associated a cluster associated with the term.

According to embodiments of the invention, textual terms may be classified, categorized or clustered. Embodiments of the invention may generate a knowledge base that may include representations of a domain generally referred to herein as an ontology. An ontology may map textual terms into clusters. Clusters may have, or be associated with, types. Exemplary types may be: Level, Department, Job Function, and Field. An ontology may map a term to any number of clusters or concepts. For example, the term “Team Leader” may be mapped to a “Manager Level” cluster and the “Manager Level” cluster may be associated with a “Level” type. Other examples may be mapping term “Recruitment” to a “Human Resources” cluster and associating cluster “Human Resources” with a “Department” type, or mapping term “Wireless” to a “Mobile” cluster and associating the “Mobile” cluster with a “Field” type. Yet other examples may be mapping term “Software Testing” to a “Quality Assurance” cluster and associating the “Quality Assurance” cluster with a “Job Function” type, or mapping term “Software Testing” to an “R&D” cluster and associating the “R&D” cluster with a “Department” type. As further described herein, clusters may be associated with scores and ranking potential customers may be based on scores associated with clusters.

An ontology may be continuously and automatically updated, e.g., as described herein. In some embodiments, input from analysts or other professionals may be received and used to update an ontology.

Classification, categorizations or other mapping of textual terms (also referred to herein as an ontology) may be continuously maintained and expanded over time and may be related to both general knowledge and domain-specific knowledge. In some embodiments, a user may associate terms with clusters and provide such mapping or association to a system. For example, either automatically or according to user input, the terms “branding”, “marketing strategy” and “E-commerce” may be associated with “marketing”. Accordingly, when these terms are found in information related to an existing customer who is to be used in order to generate a buyer profile and/or a scoring model, it may be assumed that people in the marketing department are good leads. Accordingly, “marketing” may be identified as a class or cluster that may be associated with a high score. Otherwise described, an ontology may allow making generalizations while learning from samples, by mapping textual terms into higher-level concepts. A concept, cluster, class or category may be expanded in various ways and/or over time. For example, a user may manually add terms to a category or the system may automatically add terms to a concept, class or category.

Input for a clustering module (e.g., term clustering and clustering expansion module 140) may be sets of two textual terms and a pairwise similarity metric indicating the similarity between the two textual terms in each set. The objective of a clustering module or unit may be to maximize the similarity between textual terms in the same cluster and minimize the similarity between textual terms in different clusters. For example, a method known as Hierarchical Agglomerative Clustering (HAC) may be used and a similarity metric or measure may be the semantic similarity between textual terms.

For example, a hierarchy of clusters may be built bottom-up by term clustering and clustering expansion module 140 based on information in repository 110 and publicly available information 125. Initially, each textual term identified may be a singleton cluster. At each step, the two most similar clusters may be merged together. The process may automatically terminate when all the clusters are merged into a single cluster. The hierarchy may be converted to a flat set of clusters by choosing a cutoff point. A cutoff point may be defined based on the similarity score of the merged clusters (merge similarity), e.g., cut the hierarchy when the similarity drops below some threshold, or when the gap from the previous merge score is the largest.

Possible definitions of the similarity between two clusters may be a pairwise similarity of their most similar members (single-link clustering), a pairwise similarity of their most dissimilar members (complete-link clustering) or the average of the pairwise similarities of all members of both clusters, including those that are in the same cluster (average-link clustering). Any other method or algorithm may be used in order to merge clusters.

Term clustering and clustering expansion module 140 may automatically expand and/or define clusters. For example, having identified the terms “iPhone”, “Android” and “Wireless” in information related to an existing customer, term clustering and clustering expansion module 140 may determine that “Mobile” is a significant cluster or concept in the target domain. For example, the terms “iPhone”, “Android” and “Wireless” may be associated with a common cluster named “Mobile”. In an embodiment, an association of the cluster “Mobile” with the terms “iPhone”, “Android” and “Wireless” may be based on user input.

In one embodiment, terms may be extracted from a set of existing customers known to be relevant to a domain (e.g., a product or service). For example, term extraction and counting module 135 may automatically identify and extract terms from a sample of customers and may provide term clustering and cluster expansion module 140 with extracted terms. Term clustering and cluster expansion module 140 may automatically associate extracted terms with clusters in ontology 165, e.g., using semantic similarities as described herein.

Extracted terms may be associated with clusters by a user. For example, terms extracted may be presented to a user who may associate terms with a theme, cluster, or concept. For example, a user may manually add terms to a cluster. For example, a user may associate the terms “Blackberry”, “WAP”, “smartphone” and “iOS” with the “Mobile” cluster. A significance weight, score or other metric may be associated with terms in a cluster. For example, based on a frequency of appearance of a textual term in a set of known relevant customers. In an example, a user may want to locate and/or identify customers for a wireless product. The system may examine information related to existing customers (e.g., in a CRM system) who are known to be related to the product (e.g., based on a user selection of customers in a CRM system). The system may identify that the term “Wireless” appears more frequently than the term “Android”. In such case, a score, weight or relevance associated with “Wireless” may be higher than the score or relevance associated with “Android”.

A concept, cluster or category may be associated with a score, relevance or other metric. For example, a score or weight associated with a category or cluster may be based on the cumulative significance values or scores of the related textual terms extracted from the sample and associated with the cluster or category. In other embodiments, a score of a category or cluster may be defined or modified by a user.

New, unknown, or previously unseen terms may be automatically identified. For example, upon detecting an unknown term when examining customer data, the system may access the thesaurus or synonyms sections in an online dictionary and identify terms which are similar to the unknown term. The system may further determine a cluster with which the similar terms are associated and may then associate the new term with the determined cluster. Accordingly, a system may map new or unknown terms to existing clusters.

Clusters may be created or updated based on user input. For example, a user may provide the system with a set of customers who are relevant to a product in the wireless market. The system may examine or process information related to the customers and detect that the term “iOS” appears relatively frequently. In such case, the system may display the term “iOS” to the user and prompt the user to associate the term with an existing concept, class or category or to define a new cluster or category and associate the term “iOS” with the newly created cluster. As shown by semantic similarity module 160, system 100 may include a module for determining, maintaining and/or storing parameters or other data related to semantic similarities. As shown by semantic networks 185, corpora 170, dictionaries 180 and encyclopedias 175, semantic similarity module 160 may use any source of information in order to determine similarities as described herein.

According to an exemplary flow, a system (e.g., using term clustering and cluster expansion module 140) may map extracted terms to existing clusters in ontology 165. Additional clusters may be generated, e.g., using a clustering algorithm and/or a semantic similarity as described herein. Existing clusters may be expanded with similar or relevant terms, e.g., using semantic similarity as described herein. An exemplary flow for generating, creating and/or updating clusters, classes or categories may include:

1). For each term “t” and each cluster “C” in the ontology:
a. Compute the similarity between the term and the cluster, sim(t,C)∈[0,1], which is defined as follows: if t∈C then sim(t,C)=1. Otherwise, sim(t,C) is defined as the average similarity score between t and each term in C, as computed by the semantic similarity module 160.
b. Determine if t matches C: The term “t” matches the cluster C if sim(t,C) is greater than some threshold α. Note that α can be set automatically per cluster. For instance, it may be the minimal or average similarity score over all the pairs of terms in the cluster C.

2). Import from the ontology all the clusters matched by at least one term in the sample.

3). Apply a clustering algorithm to the unmatched terms to create additional clusters.

4). Apply the semantic similarity module to expand the clusters with additional, similar terms.

A threshold may be defined by a user or it may be automatically defined by a system, for example, in the above case of term “t” and cluster “C”, threshold “α” may be defined or determined based on the minimal or average similarity score over all the pairs of terms in cluster C. Next, all clusters (e.g., in ontology 165) matched by at least one term in the sample may be examined and matching terms in the sample may be added to or associated with the clusters. New clusters may be generated (e.g., by term clustering module 140) for terms left unassociated with clusters. New and existing clusters may be expanded with new terms, e.g., as described herein.

As shown by scoring model generation module 145, system 100 may include a module or unit for generating a scoring model. A scoring model may be used to assign a numeric score to a person, a prospect or a candidate lead. Using a scoring model to associate scores with potential customers or otherwise ranking possible clients or prospects is discussed in mode detail herein. A scoring model may be stored in storage 155 as shown in FIG. 1.

As shown by search term learning module 150, system 100 may include a module for learning search terms that may be subsequently used for identifying, locating and/or retrieving candidate customers. Generally, search terms should be terms present mostly in many of the relevant profiles, should cover together well the space of relevant profiles. In an optimized set of search terms, each term in the set should contribute to the overall coverage of the relevant domain. Accordingly, highly-correlated (co-occurring) terms should be avoided. Accordingly, when examining a sample of existing customers, a system according to the invention may choose the term “t” associated with, or having the, highest TF-IDF weight in the sample, may (2) remove from the sample all the documents containing term “t” and may repeat step 1 and 2 until the sample is empty, or a predefined number of search terms are identified or determined.

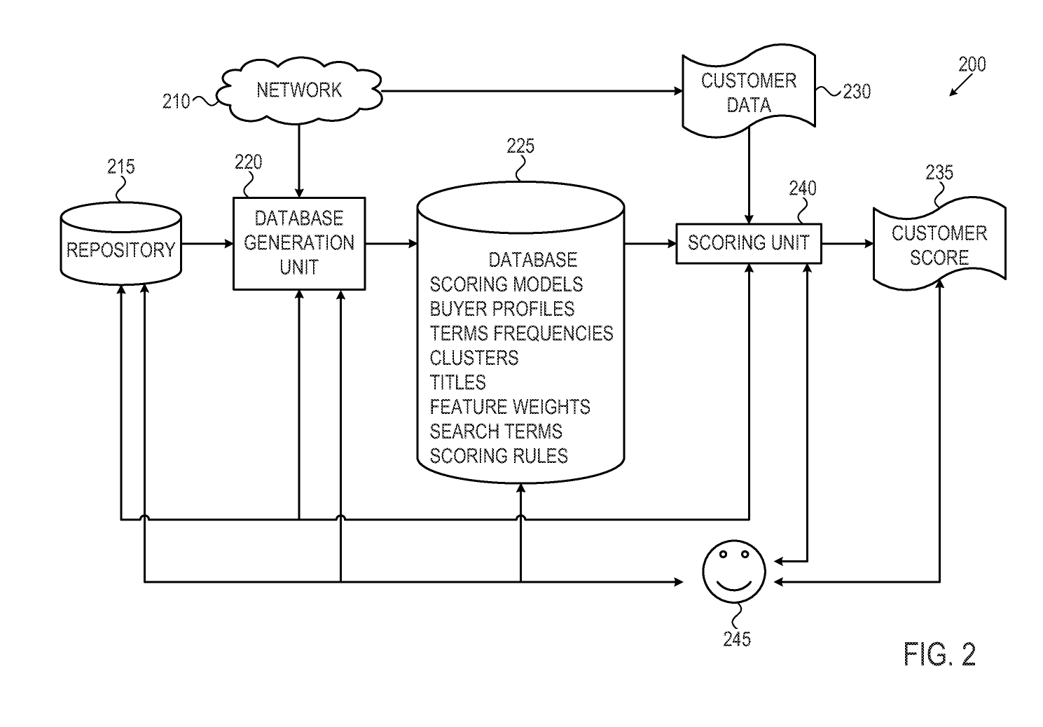

Reference is made to FIG. 2 which shows an exemplary system 200 according to embodiments of the invention. It will be understood that the system shown in FIG. 2 and described herein is an exemplary system and other systems or configurations are possible according to embodiments of the invention. Accordingly, in some implementations, some of the components shown in FIG. 2 may be omitted, replaced or combined. For example, scoring unit 240 and database generation unit 220 may be combined into a single unit, module or device.

As shown, system 200 may include a database generation unit 220, a database 225 and a scoring unit 240. As further shown, system 200 may be connected to a repository 215 and a network 210. As further shown, customer data 230 may be obtained (e.g., from network 210) and may be provided as input to scoring unit 240. Customer data 230 may be referred to herein as a lead or potential lead or candidate customer. Scoring unit 240 may use information in database 225 in order to produce customer score as shown by 235. As shown, user 245 may be provided with customer score 235. As further shown, user 245 may interact with any one of scoring unit 240, database 225, database generation unit 220 and/or repository 215. Scoring unit 240 may interact with database generation unit 220 and/or repository 215. A number of exemplary data items are shown in database 225. For the sake of simplicity and clarity, not all data objects that may be stored in database 225 are shown.

Network 210 may be or may include a private or public IP network. For example, network 210 may be connected to the internet. Additionally or alternatively, network 210 may be a global system for mobile communications (GSM) network. For example, network 210 may include or comprise an IP network such as the internet, a GSM related network and any equipment for bridging or otherwise connecting such networks as known in the art. It will be recognized that embodiments of the invention are not limited by the nature or type of network 210.

Repository 215 may be a proprietary repository, e.g., a private CRM system or other repository of customers of a company. Database 225 may be implemented using any suitable system, e.g., a storage system. For example, database 225 and repository 215 may be, or may include, any component capable of storing digital information. Database 225 and repository 215 may include or may be, for example, a hard disk drive, a Compact Disk (CD) drive, a CD-Recordable (CD-R) drive, or other suitable removable and/or fixed storage unit. Database 225 and repository 215 may include or may be a USB storage device, network storage device or FLASH storage device. It will be recognized that the scope of the present invention is not limited or otherwise affected by the type, nature, operational and/or design aspects of storage database 225 and repository 215. For example, database 225 and/or repository 215 may comprise any suitable number of possibly different storage devices without departing from the scope of the present invention.

Database generation unit 220 and scoring unit 240 may be or may include any applicable computing device. For example, database generation unit 220 and scoring unit 240 may be one or more executable codes, e.g., an application, a program, a process, task or script executed by a computing device. In other embodiments, database generation unit 220 or scoring unit 240 may be, may include, or may be implemented on, a chip, an application specific integrated circuit (ASIC) or a field programmable gate array (FPGA). Accordingly, database generation unit 220 and scoring unit 240 may be or may include hardware, firmware, software or any combination thereof.

Generally, system 200 may perform a learning task or process and a prospecting process. A result of a learning process may be a buyer profile that may be used in a prospecting process to identify, locate and/or rank potential customers. Results of a learning process may be a customer profile (or buyer profile), a scoring model, a set of search or key terms, clusters or categories of terms, feature sets (e.g., included in a scoring model) and other parameters, e.g., as shown in database 225. A prospecting process may find and rank potential leads or potential customers. In one embodiment, database generation unit 220 may perform the learning process and scoring unit 240 may perform the prospecting process.

Database generation unit 220 may retrieve and examine information in repository 215 and may generate, compute or otherwise provide scoring models, buyer profiles, terms frequencies, clusters, titles, feature sets and respective weights, search terms and scoring or ranking rules. Models, rules and other parameters provided by database generation unit 220 may be stored in database 225. Models, rules and other parameters in database 225 may be used by scoring unit 240 in order to process input customer data 230 and produce customer score 235.

Database generation unit 220 may analyze information contained in a proprietary data repository of a company, e.g., information in repository 215. Information in repository 215 analyzed by database generation unit 220 may be related to an existing customer set of the company. Based on information in repository 215, database generation unit 220 may determine or identify a first set of textual terms that characterizes a prospective customer of the company. Database generation unit 220 may analyze publicly available information in publicly available information resources to thereby determine or identify a second set of textual terms that may further characterize the prospective customers. For example, provided with a name and/or other information of an existing customer (e.g., obtained from repository 215), database generation unit 220 may search the internet or other systems for information related to the customer. Database generation unit 220 may associate at least some of the textual terms in the first and second sets with scores and may construct a customer or buyer profile based on at least some of the textual terms and scores associated therewith.

For example, database generation unit 220 may examine information related to a large number of existing customers and count the frequency of appearance of terms in the analyzed information and a score may be associated with terms based on the frequency of appearance. Accordingly, scores may be associated with textual terms based on a frequency of appearance of the textual terms in analyzed information.

When associating a term with a score based on the frequency of appearance of the term in a sample of known good customers (Term Frequency, TF), the frequency of the term within a large text collection may be computed as well. Specifically, this frequency may be defined as the number of documents in the collection containing the term (Document Frequency, DF). The score may be calculated based on the document frequency DF, together with the term frequency within the sample TF. For example, database generation unit 220 may examine corpora 170 shown in FIG. 1. As described herein, corpora 170 may be a large collection of titles and professional profiles, representing the general population of business professionals in a given field. Based on corpora 170, database generation unit 220 may determine a frequency of appearance of a term in information related to the general population of business professionals in a given domain. Database generation unit 220 may improve a scoring model by increasing the weight or score of titles or key terms whose relative frequency is much higher in a sample than in the general population, where a relative frequency may be defined as the frequency divided by the overall number of terms. Additionally or alternatively, the significance (or weight) of very common terms or features may be decreased based on information in corpora 170. Accordingly, a term score may be based on the ratio between the term frequency in the sample and the document frequency of the term in information representing the general population of professionals in a domain. This weighting scheme is known in the art as Term Frequency-Inverse Document Frequency (TF-IDF).

Database generation unit 220 may cluster terms or associate terms with categories or classes. For example, database generation unit 220 may display to user 245 a set of terms identified in a sample of customers. User 245 may mark or identify a term and indicate a cluster with which the term is to be associated. For example, database generation unit 220 may graphically display terms and categories to user 245. User 245 may use a graphical tool to indicate an association of displayed terms with clusters or categories. For example, database generation unit 220 may retrieve terms (or search terms) and cluster names or other identifications from database 225 and display clusters and terms to user 245. User 245 may associate terms with clusters, e.g., using graphical drag and drop, or by clicking a term and then clicking a cluster with which the term is to be associated. A term may be associated with any number of clusters, classes or categories.

Database generation unit 220 may automatically cluster terms or associate terms with categories or classes. For example, if a new or previously unknown term that is not associated with any cluster is detected frequently in a sample, database generation unit 220 may determine a set of other terms appearing in the sample, examine existing clusters, and, if a set of terms appearing together with the new or previously unknown term are associated with a specific cluster then the new or previously unknown term may be associated with that cluster. Similarly, if a term associated with a cluster does not appear with a predefined frequency, e.g., compared to an average appearance frequency of other terms in the cluster then database generation unit 220 may automatically remove the term from the cluster or otherwise disassociate a term from a category or class. Accordingly, clusters, classes or categories of terms may be automatically, continuously and/or dynamically updated or maintained.

Database generation unit 220 may generate scoring models or rules for matching and scoring professional profiles. Rules (e.g., generated by database generation unit 220 and stored in database 225) may be used by scoring unit 240 in order to score or rank customers. A rule for scoring a title may associate a title with a score based on a seniority level and/or based on a relevance parameter. For example, a rule may dictate that the seniority level required is “Manager” or higher. In such case, a high score may be given to a candidate customer who is a manager and a low score may be given to an engineer. A relevance parameter may measure the relatedness of a job function to the target domain. For example, a rule for a product used in testing may assign a high score to a “quality assurance” job function and a low score to other job functions, e.g., “virtualization”.

Database generation unit 220 may associate clusters with scores. In one embodiment, user 245 may assign scores to clusters, categories or classes. In another embodiment, scores may be assigned to categories automatically. For example, if terms associated with a category appear with a high frequency in a sample or set of customers, the score of the cluster may be automatically raised, e.g., by database generation unit 220. A category may be defined based on any concept, domain or parameter. For example, categories may be defined based on, or for, a business domain, a corporate entity, a job function, a job title, a seniority level within an organization, a service and a product. Categories may further be associated with a type. For example, “Mobile” may be a cluster having a type of “Field”, “Human Resources” and “Software testing” may be clusters having the type “Department”.

Database generation unit 220 may semantically analyze information related to an existing customer to identify terms related to a business domain.

Database generation unit 220 may perform semantic analysis in order to compare terms. For example, provided with two textual terms as input, database generation unit 220 may return or output a numeric score (e.g., a real number between 0 and 1) representing the degree of their similarity/relatedness. Database generation unit 220 may perform semantic analysis in order to expand clusters or categories of terms. For example, by semantically analyzing input terms and relating the analysis result to one or more terms in a cluster, database generation unit 220 may automatically add some of the input terms to a cluster.

Database generation unit 220 may use any semantic analysis, e.g., as known in the art. For example, database generation unit 220 may use Statistical corpus-based methods, e.g., Pointwise Mutual Information (PMI), Latent Semantic Analysis (LSA), and topic models such as Latent Dirichlet Allocation (LDA). Generally, Statistical corpus-based methods rely on terms occurrence in a large corpus. The basic assumptions are that terms that tend to occur together are semantically related (co-occurrence), and that terms appearing in the same contexts are semantically similar (contextual similarity or distributional similarity).

Database generation unit 220 may use Explicit Semantic Analysis (ESA) for analyzing or processing a wide-coverage collection of textual definitions, each possibly defining a concept. This method may be applied to online encyclopedias such as Wikipedia®, or dictionaries such as Wiktionary® or WordNet®. Generally, in this method, each term tᵢ is represented by a concept vector <wᵢⱼ> where the j-th entry represents the weight of tᵢ with respect to the concept cⱼ, based on a TF-IDF weighting scheme. The semantic similarity of two terms may then be computed by applying vector similarity measures (such as cosine similarity) to their concept vectors. In another embodiment, database generation unit 220 may apply measures based on semantic networks. These measures (mainly developed for the WordNet® semantic network) compute semantic similarity of two terms in a semantic network based on the network structure (e.g. the type and number of links in the path or paths connecting the two terms in the network). In an embodiment, database generation unit 220 may combine several methods. For instance, it may attempt several methods and return the maximal similarity score obtained.

Accordingly, database generation unit 220 may produce any set of terms or categories of terms based on a semantic analysis of information obtained from repository 215, network 210 or any other source. Terms produced by database generation unit 220 may be used as search terms. Search terms may be related to a title, free text or any other section of data related to a candidate customer. For example, based on a semantic analysis of titles, specific terms may be identified as search terms to be used in analyzing titles of candidate customers. Similarly, search terms may be related to a free text section, an entire professional profile or any other information related to a candidate customer.

Database generation unit 220 may generate buyers or customers profiles and store such profiles in database 225 as shown in FIG. 2. Generally, a customer or buyer profile may include or be associated with one or more sets of key or search terms and at least one scoring model. Key terms may generally be selected, identified or otherwise produced based on being highly indicative of the target domain, e.g., a product or field. For example, when processing customers in the field of cloud computing, the term “virtualization” may be identified by database generation unit 220 as a key term, e.g., based on its frequency of appearance in information related to existing customers of cloud computing products.

A score may be associated with a term based on any applicable rule, context, algorithm or any other consideration. For example, provided with access to a repository of existing customers, and possibly to additional private or proprietary databases in a company, database generation unit 220 may determine, detect or be informed of, a business transaction made by an existing customer. Database generation unit 220 may analyze information related to the existing customer and identify or determine key terms, search terms or other terms as described herein. Database generation unit 220 may then update scores associated with terms and/or clusters in database 225 based on the transaction. For example, the term “Mobile” may be associated with a first score. Database generation unit 220 may be notified of a transaction made by a customer and, upon analyzing the customer's information in repository 215, may detect the term “Mobile”. Database generation unit 220 may then raise the score of term “Mobile”. Accordingly, scores may automatically follow market trends. Any other data used for searching customers and/or ranking customers may be automatically and dynamically updated or modified by database generation unit 220. Accordingly, data objects as shown included in database 225, e.g., scores, scoring models, clusters, buyer profiles feature weights, scoring rules and search terms may all be continuously and dynamically updated by database generation unit 220 may based on any event.

Scoring unit 240 may perform a prospecting process. Scoring unit 240 may use a buyer profile (that may include a scoring model and a set of search terms) to find leads matching the buyer profile in a given company (or a list of companies), or in any other domain. For example, a prospecting process may be performed in order to find potential customers or leads for a specific product or service, in a specific geographical region or any other domain.

Generally, a prospecting process may include using the search terms in searching for person profiles of candidate leads in available data sources (e.g., professional networks and business directories), creating a feature vector, computing a score for each profile using the feature vector and feature weights. Identified leads or potential customers may be sorted, e.g., in descending order according to the computed score and a sorted list may be presented to a user. A user may be able to select potential customers for inclusion in a repository and/or for updating parameters used for searching leads.

Data related to potential customers may be provided as shown by customer data 230. Customer data 230 may be obtained by a unit or module (not shown) that may accept a reference as input and provide customer data as output. For example, an application may receive as input a company name, search the internet for information on employees of the company, locate professional profiles of employees, or any other relevant information and provide the professional profiles or other data to scoring unit 240. Retrieval of information of possible or candidate leads may be performed based on search terms produced by database generation unit 220. For example, scoring unit 240 (or another unit) may use search terms produced as described herein in order to examine information related to employees or other persons and determine, based on matching search terms whether a person or entity is to be processed by scoring unit 240, e.g., in order to associate the person with a score and/or display information related to the person to user 245. Accordingly, using search terms, system 200 may first select a set of leads or leads for review or processing. As described herein, the set of leads may be processed, scored and/or ranked.

Scoring unit 240 may use information in database 225 to process data related to potential customers. Scoring unit 240 may apply a buyer profile or a set of rules to customer data 230, and produce a score or a rank for the customer. Scoring unit 240 may identify potential customers or good leads based on a customer profile and based on customer data 230. For example, scoring unit 240 may use a scoring rule or a scoring model in order to score or rank a customer based on customer data 230. For example, scoring rules and/or scoring models generated by database generation unit 220 and stored in database 225 may be used by scoring unit 240.

A scoring model may associate a lead (e.g., provided as shown by customer data 230) with a score based on the following function:

s=Σᵢ₌₁^{k} wᵢfᵢ

where f₁ . . . fₖ are features and wᵢ . . . wₖ are features' weights.

A feature may be an event, e.g., an appearance of a term, a title or a cluster in information related to an examined potential customer, e.g., customer data 230. As referred to herein, a feature may be identified in, or extracted from, information related to a potential customer (e.g., customer data 230) in a prospecting process. For example, given an examined profile, a feature variable fₓ that gets 1 if the title in the examined profile contains the term “CTO” and 0 otherwise. Other examples for features are: (a) the appearance of the term “CTO” in the current job description section; (b) the current job title is “Head of Mobile”; (c) the cluster “Human Resources” is matched in the title. The latter feature corresponds to the event that any of the terms included in the “Human Resources” cluster is matched in the title.

Features may be associated with weights (e.g., by database generation unit 220 during a generation of a scoring function, at learning time). For example, a scoring function may associate a weight of wₓ to feature fₓ to define the contribution of feature fₓ to the overall score of an examined potential customer.

For example, when examining information related to a possible client or customer (e.g., customer data 230 found on the internet), if the term “CTO” appears in the title section of the examined information then it may be determined that a feature was detected and the feature may be associated with “1”. A weight associated with the feature (e.g., in a scoring function) may further determine the contribution of the feature to the ranking of the possible client.

When generating a scoring model, database generation unit 220 may assign weights to the features in a scoring model, e.g. the contribution of the occurrence of the word CTO in the title to the overall score. Weights may be associated with features in a job title, or in any text or content, e.g., any text or content in customer data 230.

Since a sample or set of existing customers used by database generation unit 220 in order to generate a scoring model, rules and other data in database 225 may be limited, it may not always suffice to rely solely on statistics drawn from the sample when determining weights.

Accordingly, database generation unit 220 may compute or calculate a feature's weights as the product of an empirical weight, automatically computed based on the sample statistics, and a predefined a-priori weight, which may be associated with a class of features. An a-priori weight may reflect an a-priori belief in the significance of the class. For example, consider the class of features {fᵢ(t, JTC)}, which corresponds to the occurrence of the term “t” in the current job title. Note that each term “t” corresponds to a different feature.

An empirical weight may be computed for each term, cluster or title in buyer profile. For example, a feature weight may be computed by applying a TF-IDF weighting scheme, where TF is the term, cluster or title frequency in the sample titles, and IDF is the inverse document frequency of the term, cluster or title, computed from a large corpus of person profiles. An occurrence of a cluster is defined as an occurrence of any of the terms comprising the cluster. The feature-specific empirical weight may then be multiplied by the feature class's predefined a-priori weight. Accordingly, weights may be assigned to or associated with a feature and/or weights may be assigned to, or associated with a class of features.

Any other criteria, rule or logic may be used when associating a term or a category with a weight. For example, a company size or geographic location may affect a weight. For example, a weight of a specific term may depend on a size of a company. For example, the term “CTO” may be associated with a first weight if the lead being scored is employed by a small company. The same term “CTO” may be associated with a second, different weight if the lead being scored is employed by a large company. Similarly, weights of terms may be conditioned on any applicable context, rule or criteria.

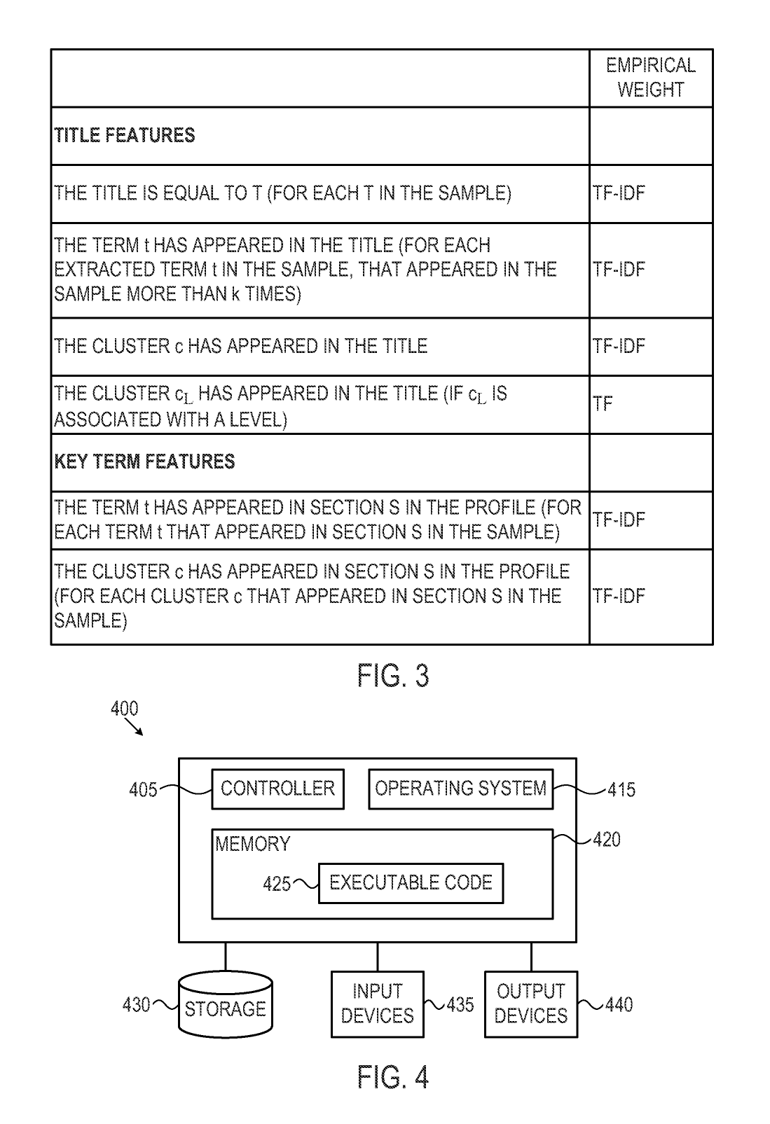

As described herein, a scoring model may include features or parameters usable for title matching and for key term matching. Features or parameters in a scoring model may be associated with weights and may further be associated with feature classes. Reference is additionally made to FIG. 3 which shows an exemplary association of empirical weights with classes of features. In some embodiments and as shown in FIG. 3, two types of features may be defined. A first type of features may be features extracted only from title sections: current job title or profile headline. A second type of features may be key term features that may be extracted from either all sections in a profile, or all the sections except titles.

As described herein, a cluster may be considered to be present in examined text if any of its members appears in the text. Otherwise described, a cluster may be considered to be present in examined text if a term associated with the cluster is detected, located or identified in the examined text. When a term or cluster appears in examined text, the associated score may be taken into account when computing a score or rank for the relevant lead or candidate customer (e.g., the person associated with customer data 230). In addition to the empirical weights described herein, in some cases fine-grained, a-priori weights may be associated with terms, features or clusters. For example, a cluster defined for a “Manager” level may be associated with an a-priori weight that may be higher than an a-priori weight associated with a “Director” cluster. Accordingly, weights contributed by features to a calculation of a score or rank may be based on weights associated with features, clusters and classes of features. Weights may be calculated and/or computed based on statistical, semantic or other analysis and/or they may be set by a user that may assign a weight to a term, category of terms, or a class of terms.

In an embodiment, scoring unit 240 may be provided with parameters, rules or other criteria and may search for leads or potential customers based on provided criteria. For example, user 245 may provide scoring unit 240 with a name or type of a company and scoring unit 240 may search for leads in the indicated company or in companies of an indicated type. Any other criteria, e.g., a product or service may be similarly provided to scoring unit 240. Using a customer or buyer profile, scoring unit 240 may identify terms in leads retrieved (e.g., from the internet). Scoring unit 240 may use a scoring function to associate retrieved leads with scores. A scoring function may associate a potential lead with a score based on a scoring model and terms identified or found in information related to the potential lead. For example, the terms in information related to a potential lead (e.g., as shown by customer data 230) may be related to terms in a buyer model and a scoring or matching function may calculate a score for the potential lead based on matched terms and associated weights. Accordingly, the higher the match between terms appearing in customer data 230 and terms in a buyer profile, the higher may the score of the relevant customer be. Similarly, higher weights associated with matched terms may cause a matching or scoring function to produce a higher score.

Only some exemplary methods and calculations performed in order to rank a potential customer are described in detail herein. It will be understood that scoring unit 240 may use any information in database 225 in order to rank a potential customer. For example, when identifying a term in customer data 230, scoring unit 240 may determine the term is associated with a specific cluster and may rank the potential customer based on the cluster and not based on the term. Accordingly, a customer may be ranked based on one or more identified features or terms, based on an associated cluster, based on a type of an associated cluster or based on any combination thereof.

As shown by the arrows connection scoring unit 240, database generation unit 220 and repository 215, system 200 may operate in closed loop mode. In an embodiment, scoring unit 240 may update a sample of leads in repository 215. For example, after identifying and ranking a set of potential leads as described herein, scoring unit 240 may automatically (e.g., without any command or input from user 245) select, based on associated scores, a top percentage of the leads and may store selected leads in repository 215, thus increasing the size of the sample of customers. Accordingly, a sample or set of customers based on which a buyer profile may be generated may be dynamically updated. Database generation unit 220 may perform (or repeat) a learning process based on an updated sample of customers. Accordingly, in closed loop mode, system 200 may continuously, automatically and dynamically update a buyer profile based on leads identified by system 200.

Customers identified by scoring unit 240 may be monitored. For example, customers imported into a system (e.g., stored in repository 215) may be monitored, e.g., database generation 220 may be informed when a customer selected by scoring unit 240 has actually engaged in a purchase. Based on indications such as a purchase or transaction with a customer, database generation 220 may update a buyer model. For example, terms found in a profile of a customer who has recently purchased a relevant product may be added to a set of search terms or weights of features in a scoring model may be updated to based on the customer's profile or other data. Accordingly, system 200 may dynamically, automatically and continuously update a buyer model based on business activities of customers. Otherwise described, system 200 may automatically update and/or improve a buyer model, search terms or any other parameter used for finding and/or identifying good leads based on actual business results.

Automatic, dynamic and/or continuous improvement of a buyer model, search terms or any data or parameters used for identifying potential customers or leads may include on going study of terms or aspects related to an industry, field, product, service or any other domain. For example, information as described with reference to corpora 170 as shown by FIG. 1. For example, based on a product name or a set of terms related to a technology, information or data may be obtained, e.g., from the internet or other online resources. For example, based on the term “Mobile” internet sites of companies may be accessed and any relevant information, including professional profiles or other data (e.g., as described with reference to customer data 230) may be obtained. Likewise, online encyclopedia, magazines or dictionaries may be accessed to retrieve information.

Obtained information may be analyzed (e.g., by database generation unit 220) and relevant terms may be identified. Accordingly, system 200 may continuously, dynamically and automatically update a knowledge base. Consequently, system 200 may automatically and continuously map terms (and their respective frequencies or other aspects) in an industry, field, technology or domain. Terms learned automatically as described herein may be used in a generation or maintenance of a buyer model, e.g., features and weights may be updated based on automatically learned terms. For example, during a first period, a specific term may be only be used in relation to a specific field or product. In such case, the term may be added to a set of search terms used to find leads for the specific product. However, with time, the term may appear in other fields and may thus be less indicative of the specific product. By continuously learning terms relevant to many fields, industries or other domains and/or mapping terms in domains according to frequencies or other aspects, system 200 may deduce the specific term is no longer highly indicative of the specific product. Accordingly, system 200 may lower a weight of a feature related to the specific term or it may exclude the term from a set of search terms.

In another aspect, system 200 may automatically identify terms which are common to a wide variety of industries or domains and deduce that such terms may not be indicative of a specific industry and update a buyer profile accordingly. For example, database generation unit 220 may lower a weight of a feature in a buyer profile generated for a specific product if the relevant feature is identified or present in professional profiles related to many products.

Upon updating a buyer model, a set of search terms or any other information, parameters or data relevant to identifying customers, e.g., data stored in database 225, a prospecting process may be repeated. For example, upon updating a scoring model or a set of search terms, database generation 220 may cause scoring unit 240 (and possibly other units, e.g., a customer data retrieval unit not shown in FIG. 2) to repeat a process of finding potential leads or customers, e.g., search the internet for potential customers or leads and to further score leads found based on an updated scoring model, buyer profile or any updated parameter.

Search terms may be continuously, automatically and dynamically updated. For example, database generation unit 220 may identify new terms in information related to customers which were automatically selected and provided by scoring unit 240 as described above. As technology evolves, new terms may appear in a specific field or domain. For example, the term “tablet” may not have been common in professional profiles (e.g., related to mobile devices) prior to the introduction of tablet computer or during the early stages of these products. By automatically examining (possibly top or selected) leads selected by scoring unit 240 as described, when a new term such as “tablet” appears in the industry, database generation 220 may detect that the term appears in profiles of professionals related to the mobile industry and may automatically add the term “tablet” to a set of search terms. Accordingly, system 200 may automatically, dynamically and continuously expand or update the set of search terms used as described herein. Otherwise described, system 200 may learn terms as they are introduced to a field, technology or other domain and may use such automatically learned terms in searching for potential customers. Similarly, by examining leads automatically selected in provided by scoring unit 240, database generation unit 220 may adjust weights of terms (e.g., based on statistical considerations such as frequency of appearance). Database generation unit 220 may add, remove or update term categories and/or categories classes based on leads selected and provided by scoring unit 240.

As shown by the arrows connecting user 245 with scoring unit 240, database 225, database generation unit 220 and repository 215, a user may interact with various components of system 200. For example, a buyer profile may be updated based on feedback or input from a user. According to some embodiments, a user may directly modify a buyer profile. For example, using a graphical user interface (GUI) application, user 245 may directly interact with database 225 to modify a buyer profile, add or delete search terms, adjust a weight of a term or category etc. Generally, any parameter, rule or other content or object used by system 200 may be modified or manipulated by user 245. For example, any data stored in database 225 and used by scoring unit 240 and/or database generation unit 220 may be accessed and/or modified by user 245.

For example, user 245 may add or remove search terms from database 225. For example, a user may add negative terms that may indicate that a profile is a bad match, and therefore should reduce the score. For example, a user may want to find leads who are not located in the east coast, accordingly, a negative term “east coast” may be added to a buyer profile to cause scoring unit 240 to exclude customers located in the east cost from a list of customers provided to a user. In other embodiments, a score given to or associated with a potential lead may be lowered if negative terms appear in the potential lead's profile or in other examined information. User 245 may modify clusters or categories, e.g., add terms to a cluster, remove terms from a cluster, merge or split clusters etc. User 245 may modify any of the feature weights, e.g., per-class a-priori weights or specific empirical weights. Directly interacting with system 200, e.g., with database 225, user 245 may add, delete or modify search terms.

Direct interaction or modification of parameters as described herein may require a certain level of expertise or knowledge. Accordingly, in some embodiments, user 245 may modify a buyer profile indirectly, e.g., by indicating a lead provided by scoring unit 240 as a good lead or as a bad lead. A buyer profile may be modified based on user indication that a lead provided by scoring unit 240 is a bad or unsuitable lead. For example, database generation unit 220 may be provided with information related to a lead that may further be indicated as a bad lead (e.g., by user 245). Database generation unit 220 may detect, identify or locate terms in such information and modify a buyer profile, a set of search terms or a scoring model based on identified terms. For example, terms in a set of search terms also found in information related to an indicated bad lead may be removed from the set such that leads similar to the bad lead are not identified as possible leads. In a similar way, weights of terms, categories or classes may be modified, e.g., lowered, based on an indicated bad lead.

User 245 may provide feed back by marking leads or profiles provide by scoring unit 240 as either good or bad. This feedback may be explicit, or implicit. For example, provided with a list of leads by scoring unit 240, user 245 may select a lead from the list or otherwise indicate the lead is a good lead. In such case, the lead may be automatically added to repository 215, e.g., by storing any relevant information. Accordingly, a sample of leads may be extended or updated based on user input. In another embodiment, when user 245 clicks on a profile, database generation unit 220 may regard the profile as a possible match (but possibly not a good match or good lead) and may prompt the user for additional selections, or it may update a buyer profile accordingly. For example, parameters in database 225 may be modified with a high level of confidence when a user actually selects a new lead to be included in repository 215, but may be updated according to a lower confidence level when a lead is indicated as a possible lead. For example, the rate, percentage or factor according to which weights in a scoring model are modified may be based on whether a lead is indicated as a good lead or a possible lead.

Database generation unit 220 may act based on user feedback in various ways. Generally, user feedback may indicate that a lead, term or rule is a negative example or a positive one. For example, a negative example (e.g., as indicated by a user) may be used by database generation unit 220 in order to delete search terms from a set of search terms used to find potential customers. In another embodiment, weights of features (e.g., in a scoring model) may be lowered based on an indication of a bad or unsuitable lead. For example, database generation unit 220 may examine information related to an indicated bad lead, identify terms therein and lower the weights of the identified in a buyer profile. Similarly, based on an indication of a good lead, database generation unit 220 may raise weights of features or add terms to a set of search terms.

One way to incorporate user's feedback into a model or buyer profile may be to assume that the additional examples are added to the sample, and redo learning. Positive examples may be treated by database generation unit 220 the same as any other profile in the sample. Negative examples may be treated as having a negative term frequency (TF). Alternatively, database generation unit 220 may update a weight vector w based on an example whose feature vector is fᵢ−fₖ using the following update rule: wᵢ←wᵢ+δuwᵢfᵢ, where δ is “1” if the example is a good match and “−1” if the example is a bad match, and α controls the magnitude of the influence of the examples on the weight vector. Accordingly, positive leads may move weights of features that match a lead in a first, positive direction and negative leads may move these weights in the opposite direction, where the magnitude of the change is controlled by α.

Reference is made to FIG. 4, showing high level block diagram of an exemplary computing device 400 according to embodiments of the present invention. Computing device 400 may include a controller 405 that may be, for example, a central processing unit processor (CPU), a chip or any suitable computing or computational device, an operating system 415, a memory 420, a storage 430, an input devices 435 and an output devices 440. In an embodiment, system 200 described herein with reference to FIG. 2 may be implemented using device 400.

Operating system 415 may be or may include any code segment designed and/or configured to perform tasks involving coordination, scheduling, arbitration, supervising, controlling or otherwise managing operation of computing device 400, for example, scheduling execution of programs. Operating system 415 may be a commercial operating system. Memory 420 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 may be or may include a plurality of, possibly different memory units.

Executable code 425 may be any executable code, e.g., an application, a program, a process, task or script. Executable code 425 may be executed by controller 405 possibly under control of operating system 415. For example, executable code 425 may be one or more applications implementing database generation unit 220 and/or scoring unit 240. Storage 430 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage 430 and may be loaded from storage 430 into memory 420 where it may be processed by controller 405. For example, storage 430 may include repository 215 and/or database 225 and content stored in storage 430 may be a buyer profile, a scoring model or other content stored in database 225 as described herein.

Input devices 435 may be or may include a mouse, a keyboard, a touch screen or pad or any suitable input device. For example, input devices 435 may enable user 245 to interact with a system, e.g., in order to indicate good and/or bad leads. It will be recognized that any suitable number of input devices may be operatively connected to computing device 400 as shown by block 435.

Output devices 440 may include one or more displays, speakers and/or any other suitable output devices. For example, output devices 440 may be used in order to display a sorted list of ranked leads. It will be recognized that any suitable number of output devices may be operatively connected to computing device 400 as shown by block 440. Any applicable input/output (I/O) devices may be connected to computing device 400 as shown by blocks 435 and 440. For example, a wired or wireless network interface card (NIC), a printer or facsimile machine, a universal serial bus (USB) device or external hard drive may be included in input devices 435 and/or output devices 440.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 420, computer-executable instructions such as executable code 425 and a controller such as controller 405.

Some embodiments may be provided in a computer program product that may include a non-transitory machine-readable medium, stored thereon instructions, which may be used to program a computer, or other programmable devices, to perform methods as disclosed herein. For example, executable code 425 may be such instructions. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a network device, or any other suitable computing device.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A computer-based method performed by a processor comprising:
analyzing information contained in a proprietary data repository of a company, the information being related to an existing customer set of the company, to thereby determine a first set of textual terms;
analyzing publicly available information related to the existing customer set to thereby determine a second set of textual terms;
associating at least some of the textual terms in the first and second sets with scores;
constructing a customer profile based on at least some of the textual terms and scores associated therewith; and
identifying potential customers for the company based on the customer profile and based on publicly available information.

2. The method of claim 1, comprising ranking identified potential customers based on the customer profile and based on publicly available information related to the potential customers.

3. The method of claim 1, wherein the first and second sets of textual terms characterize a prospective customer of the company.

4. The method of claim 1, wherein associating a textual term with a score comprises:
determining a plurality of categories and associating each of the categories with a respective category score;
associating a textual term with a category; and
associating the textual term with a score based on the category score associated with the category.

5. The method of claim 4, wherein the categories are defined based on at least one of: a business domain, a corporate entity, a job function, a job title, a seniority level within an organization, a service and a product.

6. The method of claim 1, wherein the scores are associated with textual terms based at least on a frequency of appearance of the textual terms in the analyzed information.

7. The method of claim 1, comprising semantically analyzing information related to an existing customer to identify terms related to the business domain.

8. The method of claim 1, comprising:
receiving a company name;
obtaining information related to a plurality of employees of the company;
using the customer profile and a matching function to associate the plurality of employees with a respective plurality of scores.

9. The method of claim 1, comprising receiving an indication of at least one of: a service and a product and providing a sorted list of potential buyers, wherein the sorted list is sorted according to scores calculated based on the customer profile and one of: the service and the product.

10. The method of claim 1, comprising updating the customer profile based on information related to potential customers selected by a user.

11. The method of claim 1, comprising:
identifying a term in information related to a company's existing customer;
determining a status of a business transaction related to the customer; and
associating the term with a score based on the business transaction.

12. The method of claim 1, wherein publicly available information includes personal profiles.

13. An article comprising a non-transitory computer-readable storage medium, having stored thereon instructions, that when executed on a computer, cause the computer to:
analyze information contained in a proprietary data repository of a company, the information being related to an existing customer set of the company, to thereby determine a first set of textual terms;
analyze publicly available information related to the existing customer set to thereby determine a second set of textual terms;
associate at least some of the textual terms in the first and second sets with scores;
construct a customer profile based on at least some of the textual terms and scores associated therewith; and
identify potential customers for the company based on the customer profile and based on publicly available information.

14. The article of claim 13, wherein the instructions when executed further result in ranking identified potential customers based on the customer profile and based on publicly available information related to the potential customers.

15. The article of claim 13, wherein the first and second sets of textual terms characterize a prospective customer of the company.

16. The article of claim 13, wherein associating a textual term with a score comprises:
determining a plurality of categories and associating each of the categories with a respective category score;
associating a textual term with a category; and
associating the textual term with a score based on the category score associated with the category.

17. The article of claim 16, wherein the categories are defined based on at least one of: a business domain, a corporate entity, a job function, a job title, a seniority level within an organization, a service and a product.

18. The article of claim 13, wherein the scores are associated with textual terms based at least on a frequency of appearance of the textual terms in the analyzed information.

19. The article of claim 13, wherein the instructions when executed further result in semantically analyzing information related to an existing customer to identify terms related to the business domain.

20. The article of claim 13, wherein the instructions when executed further result in:
receiving a company name;
obtaining information related to a plurality of employees of the company;
using the customer profile and a matching function to associate the plurality of employees with a respective plurality of scores.
